(19) United States
(12) Patent Application Publication
(10) Pub. No.: US 2025/0033913 A1
(43) Pub. Date: Jan. 30, 2025

(54) IMAGE FORMING APPARATUS

(71) Applicant: CANON KABUSHIKI KAISHA, Tokyo (JP)

(72) Inventor: NORIAKI MATSUI, Chiba (JP)

(21) Appl. No.: 18/782,514

(22) Filed: Jul. 24, 2024

(30) Foreign Application Priority Data
Jul. 25, 2023 (JP) 2023-120844

(51) Int. Cl. B65H 7/02; B65H 5/02; B65H 7/20

(52) U.S. Cl. CPC B65H 7/02; B65H 5/021; B65H 7/20; B65H 2301/42134

(57) ABSTRACT

An image forming apparatus includes a sheet feeder in which sheets are to be loaded, a conveyor configured to feed each of the sheets from the sheet feeder, a sensor configured to detect a sheet property of the each of the sheets conveyed by the conveyor, an image forming portion configured to form an image on the each of the sheets conveyed by the conveyor, and a controller configured to control the image forming portion to form an image on each of a plurality of sheets in accordance with an operating condition based on the sheet property detected with the sensor in a case where a job for forming an image on the plurality of sheets is executed.

### BACKGROUND OF THE INVENTION

### Field of the Invention

The present disclosure relates to an image forming apparatus, such as a printer, a copying machine, and a multifunction machine, including a media sensor capable of detecting a sheet property, such as a surface property and thickness, of a sheet of paper being conveyed through the image forming apparatus.

### Description of the Related Art

Electrophotographic image forming apparatus are each equipped with a sheet feeder, such as a sheet feeding cassette and a manual feeding tray, from which one sheet of paper is fed at a time so that an image is printed on the fed sheet of paper. Different types of sheets have different sheet properties, such as different surface properties and different thicknesses. Image forming apparatus determine operating conditions for image forming control (e.g., control associated with feeding, development, image transfer, and fixing) in accordance with the sheet property of the sheet of paper before printing an image on the sheet. Examples of the operating conditions include a sheet conveyance speed, a development bias voltage applied during development, a transfer bias voltage applied during image transfer, and a fixing temperature.

Although settings pertaining to sheet properties may be made manually by a user, an automatic setting by means of a media sensor arranged on a sheet conveyance path has been proposed. Such an image forming apparatus which includes a media sensor can determine the sheet property of sheets of paper being conveyed through use of the media sensor, and can automatically determine the operating conditions for image forming control based on the sheet property (U.S. Pat. No. 10,491,767). A sheet of paper is conveyed through the image forming apparatus upon sheet replacement, startup, or deactivation of a power saving mode for a low-power standby state, for example. The image forming apparatus detects the sheet property of the sheet of paper and then determines the operating conditions based on the detected sheet property.

Once the sheet property of the first sheet of paper is determined through use of the media sensor, the operating conditions for image forming control are determined based on the sheet property of the first sheet of paper, and the same operating conditions are applied to the second and subsequent sheets of paper. In a case where running out of sheet occurs in the sheet feeder during execution of a print job for forming an image on a plurality of sheets of paper, the image forming apparatus temporarily suspends the job. In the event of such a temporary suspension, the sheet feeder may be replenished with sheets of paper whose property differs from the property of sheets of paper loaded before the suspension.

### SUMMARY OF THE INVENTION

An image forming apparatus according to one embodiment of the present disclosure includes a sheet feeder in which sheets are to be loaded, a conveyor configured to feed each of the sheets from the sheet feeder, a sensor configured to detect a sheet property of the each of the sheets conveyed by the conveyor, an image forming portion configured to form an image on the each of the sheets conveyed by the conveyor, and a controller configured to control the image forming portion to form an image on each of a plurality of sheets in accordance with an operating condition based on the sheet property detected with the sensor in a case where a job for forming an image on the plurality of sheets is executed, wherein, in a case where image formation is suspended before completion of the job, the controller is configured to control, depending on a factor responsible for the suspension of the image formation, whether to redetect a sheet property with the sensor upon resumption of the job is made.

Further features of the present invention will become apparent from the following description of exemplary embodiments (with reference to the attached drawings).

### BRIEF DESCRIPTION OF THE DRAWINGS

FIG. 1 is a configuration diagram of an image forming apparatus.

FIG. 2 is an explanatory diagram of a control unit.

FIG. 3 is a configuration diagram of a media sensor.

FIG. 4 is an explanatory table of sheet identification results.

FIG. 5 is an explanatory table of sheet feeding stage information.

FIG. 6 is an exemplary view of a setting screen.

FIG. 7 is an exemplary view of a selection screen.

FIG. 8 is an exemplary view of an automatic setting screen.

FIG. 9 is an exemplary view of a setting screen.

FIG. 10 is a flowchart for illustrating processing for making settings concerning sheet feeding stage information.

FIG. 11 is a flowchart for illustrating media automatic identification processing.

FIG. 12 is an exemplary view of a display screen on which a suspension factor is indicated.

FIG. 13 is an exemplary view of a notification screen.

FIG. 14 is a flowchart for illustrating job-start-time sheet detection processing.

FIG. 15 is a configuration diagram of another example of a media sensor.

### DESCRIPTION OF THE EMBODIMENTS

Now, referring to the accompanying drawings, description is given of at least one preferred embodiment of the present disclosure.

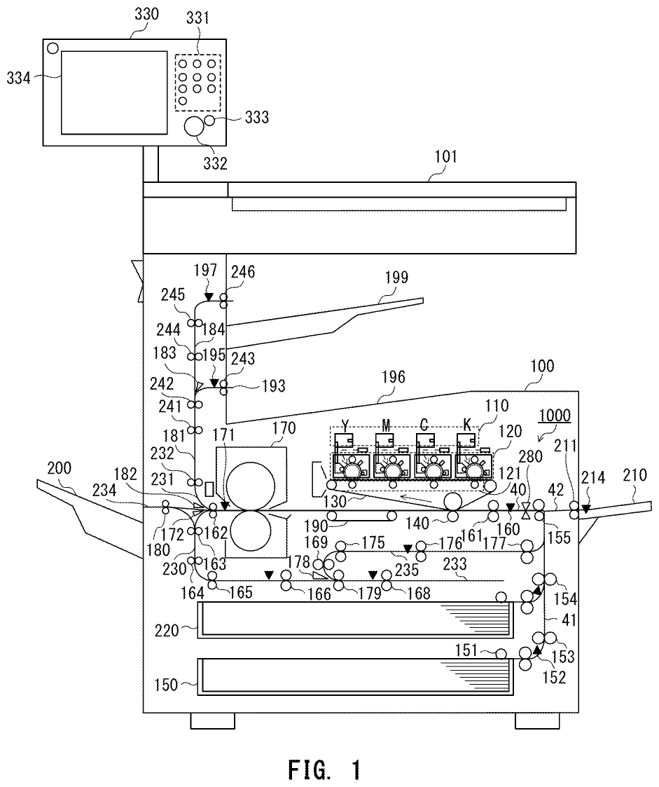

FIG. 1 is a configuration diagram of an image forming apparatus according to the at least one embodiment. An image forming apparatus 100 includes a scanner portion 101 and a user interface (UI) 330, which are installed in the top portion of the image forming apparatus 100. This image forming apparatus 100 can be implemented by, for example, a copying machine, a multifunction machine, or a multifunction peripheral (MFP).

The scanner portion 101 reads an image from an original at the time of copying or facsimile transmission. The scanner portion 101 then transmits to the image forming apparatus 100 image data indicating the image read from the original. When operating as a copying machine, the image forming apparatus 100 forms an image on a sheet (in the present embodiment, a sheet of paper) based on the image data acquired from the scanner portion 101.

The UI 330 is an operating unit including an input interface and an output interface. Components included in the input interface of the UI 330 include various key buttons, such as a numeric keypad 331, a start key 332, and a stop key 333, and a touch panel. Components included in the output interface of the UI 330 include a display 334 and a speaker. The user can input various commands and settings to the image forming apparatus 100 by using the UI 330. The UI 330 can display, on the display 334, a screen on which the user can input commands and settings for operating the image forming apparatus 100 or a screen which shows an operating status of the image forming apparatus 100.

The image forming apparatus 100 includes a laser scanner unit 110, a process unit 120, a primary transfer portion 121, a transfer belt 130, a secondary transfer portion 140, a fixing portion 170, sheet feeding cassettes 150 and 220, and a feeding mechanism 1000. Sheets of paper are loaded in the sheet feeding cassettes 150 and 220 and are fed by the feeding mechanism 1000. In the image forming apparatus 100, an image (toner image) formed by the process unit 120 and the laser scanner unit 110 is transferred by the primary transfer portion 121, the transfer belt 130, and the secondary transfer portion 140 onto a sheet of paper fed by the feeding mechanism 1000. The toner image is fixed to the sheet of paper by the fixing portion 170 of the image forming apparatus 100. The sheet of paper having an image thus printed thereon is then delivered to a delivery port A 200, a delivery port B 196, or a delivery port C 199.

The process unit 120 includes photosensitive drums, developing devices, charge rollers, photosensitive drum cleaners, and the like. In the process unit 120, the charge rollers charge the surfaces of the respective photosensitive drums, and the laser scanner unit 110 then radiates laser beams to form a latent image on each of the photosensitive drums. The laser scanner unit 110 irradiates the photosensitive drums with laser beams modulated based on image data acquired from the scanner portion 101 or an external device, such as a personal computer. As a result, latent images based on the image data are formed on the photosensitive drums.

The latent images formed on the photosensitive drums are developed with toner in the developing devices. In the development stage, images (toner images) are formed on the photosensitive drums. The process unit 120 in the at least one embodiment includes four photosensitive drums with which color images are created. The four photosensitive drums are provided for formation of toner images rendered in four different colors. In the at least one embodiment, toner images on the four photosensitive drums are rendered in yellow (Y), magenta (M), cyan (C), and black (K), respectively. In a case where a monochrome image is created, a toner image is rendered in black only.

The primary transfer portion 121 applies a primary transfer bias voltage to the toner images on the photosensitive drums so that the toner images are transferred onto the transfer belt 130. The toner images on the four photosensitive drums are transferred, one after another, onto the transfer belt 130. The toner images rendered in the respective colors are superimposed on top of one another over the transfer belt 130. After being transferred onto the transfer belt 130, the toner images rendered in the respective colors are conveyed to the secondary transfer portion 140 by rotation of the transfer belt 130. After the transfer of toner images, any remaining toner on the photosensitive drums is cleaned by the respective photosensitive drum cleaners before the photosensitive drums are used for the following image forming operation.

Sheets of paper are loaded in the sheet feeder or, more specifically, the sheet feeding cassettes 150 and 220 and a manual feeding tray 210 and are fed at the time when the process unit 120 starts performing image forming operation. Each sheet of paper fed from the sheet feeder is conveyed along a conveyance path 40 to the secondary transfer portion 140. Sheets of paper loaded in the sheet feeding cassette 150 are each fed through a conveyance path 41 by a pickup roller 151. On the conveyance paths 40 and 41 between the sheet feeding cassette 150 and the secondary transfer portion 140, conveyance rollers A 153, conveyance rollers B 154, conveyance rollers C 155, and pre-registration conveyance rollers 161 are arranged to convey sheets of paper fed from the sheet feeding cassette 150. Sheets of paper placed on the manual feeding tray 210 are each fed through a conveyance path 42 by pickup rollers 211. On the conveyance paths 40 and 42 between the manual feeding tray 210 and the secondary transfer portion 140, the conveyance rollers C 155 and the pre-registration conveyance rollers 161 are arranged to convey sheets of paper fed from the manual feeding tray 210. The pre-registration conveyance rollers 161 convey a sheet of paper to the secondary transfer portion 140 right at the time when the toner images borne on the transfer belt 130 are conveyed to the secondary transfer portion 140.

A pickup sensor 152 is arranged between the pickup roller 151 and the conveyance rollers A 153. A manual-feeding sheet detection sensor 214 is arranged at the proximal end of the manual feeding tray 210. On the conveyance path 40, a first conveyance sensor 160 and a media sensor 280 are arranged between the conveyance rollers C 155 and the pre-registration conveyance rollers 161.

The secondary transfer portion 140 applies a secondary transfer bias voltage to the sheet of paper and the toner images such that the toner images rendered in the respective colors are transferred onto the sheet of paper all at once as a single toner image. Following the transfer of the toner image onto the sheet of paper at the secondary transfer portion 140, the sheet of paper is conveyed to the fixing portion 170. A conveyance belt 190 is arranged between the secondary transfer portion 140 and the fixing portion 170. The conveyance belt 190 conveys the sheet of paper to the fixing portion 170.

While being conveyed by the fixing portion 170, the sheet of paper with the toner image transferred thereto is nipped in the fixing portion 170, and the fixing portion 170 fixes and melts the toner image to the sheet of paper by heating to a predetermined fixing temperature and by the application of pressure. As a result, the image is fixed to the sheet of paper. The sheet of paper with the image fixed thereto is then conveyed to one of a conveyance path C 234, a conveyance path B 231, or a conveyance path A 230. Thus, a flapper A 172 and a flapper B 182 are arranged on a downstream side of the fixing portion 170 in a conveyance direction of the sheet of paper. Conveyance rollers D 162 and a second conveyance sensor 171 are arranged between the fixing portion 170 and the flappers A 172 and B 182.

On the conveyance path C 234, delivery rollers 180 are arranged. The delivery rollers 180 deliver the sheet of paper to the delivery port A 200. The conveyance path B 231 is connected to a conveyance path D 181. The conveyance path D 181 branches into a delivery path A 193 and a delivery path B 184, which lead to the delivery port B 196 and the delivery port C 199, respectively. A flapper 183 is arranged at the point at which the delivery path A 193 and the delivery path B 184 branch off. On the conveyance path B 231 and the conveyance path D 181, conveyance rollers E 232, delivery rollers A 241, and delivery rollers B 242 are arranged.

On the delivery path A 193, delivery rollers C 243 and a first delivery sensor 195 are arranged. Each sheet of paper diverted to the delivery path A 193 by the flapper 183 is delivered to the delivery port B 196 by the delivery rollers C 243. On the delivery path B 184, delivery rollers D 244, delivery rollers E 245, delivery rollers F 246, and a second delivery sensor 197 are arranged. Each sheet of paper diverted to the delivery path B 184 by the flapper 183 is delivered to the delivery port C 199 by the delivery rollers D 244, the delivery rollers E 245, and the delivery rollers F 246.

On the conveyance path A 230, reverse rollers 163, duplex conveyance rollers A 164, duplex conveyance rollers B 165, duplex conveyance rollers C 166, duplex conveyance rollers D 179, and duplex conveyance rollers E 168 are arranged. The conveyance path A 230 is connected to a duplex reverse conveyance path 233.

For single-sided printing in which a sheet of paper is to be delivered to the delivery port A 200 with the print side facing down, the reverse rollers 163 reverse the direction of rotation immediately before the rear end of the sheet of paper diverted to the conveyance path A 230 by the flapper A 172 passes through the reverse rollers 163. Upon reversal of the direction of rotation, the sheet of paper is conveyed toward the delivery rollers 180. Further, for double-sided printing in which a sheet of paper is to be conveyed to the duplex reverse conveyance path 233 after an image is printed on a first side of the sheet of paper, the reverse rollers 163 convey the sheet of paper without reversing the direction of rotation. The sheet of paper is thus conveyed to the duplex reverse conveyance path 233 via the reverse rollers 163, the duplex conveyance rollers A 164, the duplex conveyance rollers B 165, the duplex conveyance rollers C 166, the duplex conveyance rollers D 179, and the duplex conveyance rollers E 168.

The duplex reverse conveyance path 233 is connected to a duplex conveyance path 235 for conveying a sheet of paper to the conveyance path 41. A sheet of paper conveyed to the duplex reverse conveyance path 233 is then conveyed in the reverse direction such that the sheet of paper is conveyed to the duplex conveyance path 235. For this purpose, a flapper 178 is arranged at the point at which the duplex conveyance path 235 branches off. On the duplex conveyance path 235, duplex conveyance rollers F 169, duplex conveyance rollers G 175, duplex conveyance rollers H 176, and duplex conveyance rollers I 177 are arranged. A plurality of sensors for detecting a sheet of paper are arranged also on the duplex reverse conveyance path 233 and the duplex conveyance path 235.

A sheet of paper undergoing double-sided printing is conveyed to the duplex reverse conveyance path 233, and the conveyance is temporarily halted at a time when the rear end of the sheet of paper passes through the duplex conveyance rollers D 179. The duplex conveyance rollers E 168 then reverse the direction of rotation to convey the sheet of paper in the opposite direction. The flapper 178 guides the sheet of paper into the duplex conveyance path 235. The sheet of paper guided into the duplex conveyance path 235 is conveyed to the conveyance path 41 by the duplex conveyance rollers F 169, the duplex conveyance rollers G 175, the duplex conveyance rollers H 176, and the duplex conveyance rollers I 177. As a result of a series of actions, the print side of the sheet of paper is switched from the first side of the sheet of paper to the reverse side, that is, to a second side of the sheet of paper. The sheet of paper conveyed to the conveyance path 41 is then conveyed to the secondary transfer portion 140, and an image is printed on the second side just like the way in which an image was printed on the first side.

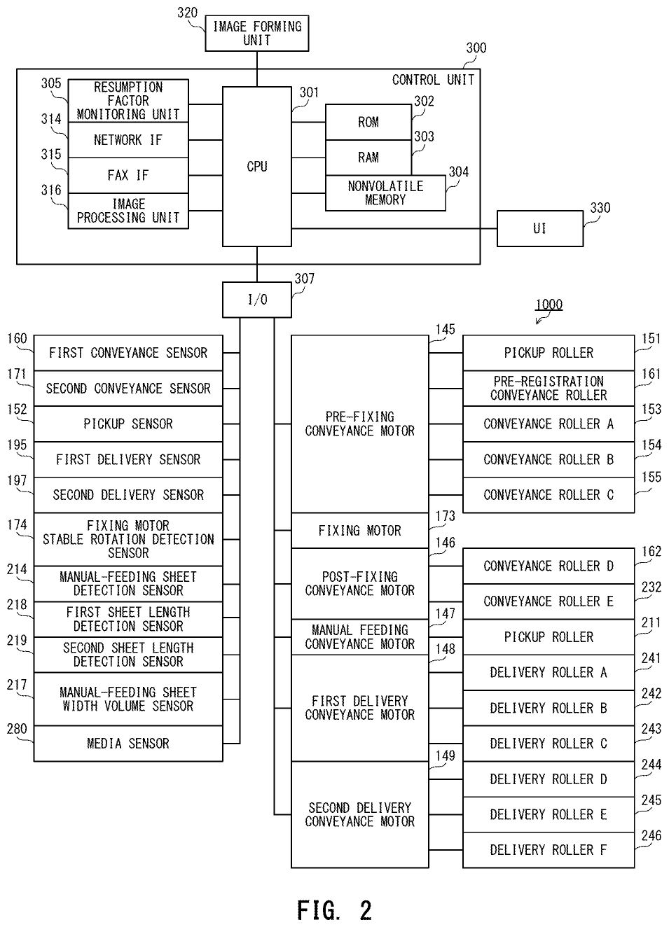

FIG. 2 is an explanatory diagram of a control unit that controls the operation of the image forming apparatus 100 configured as described above. A control unit 300 is built in the image forming apparatus 100. The control unit 300 is an information processing device including a central processing unit (CPU) 301, a read-only memory (ROM) 302, a random access memory (RAM) 303, and a non-volatile memory 304. The control unit 300 includes, in addition to the above, a resumption factor monitoring unit 305, a network interface (I/F) 314, a fax interface (I/F) 315, and an image processing unit 316. The control unit 300 is connected to an image forming portion 320 as an image forming unit, the UI 330, and an I/O 307. For example, in a case where a job is suspended before completion, the resumption factor monitoring unit 305 monitors the occurrence of an incident that can cause resumption of the job.

The I/O 307 is connected to various sensors provided in the image forming apparatus 100 and various motors serving as drive sources for the feeding mechanism 1000. Examples of the various motors include a pre-fixing conveyance motor 145, a fixing motor 173, a post-fixing conveyance motor 146, a manual feeding conveyance motor 147, a first delivery conveyance motor 148, and a second delivery conveyance motor 149. Examples of the various sensors include the first conveyance sensor 160, the second conveyance sensor 171, the pickup sensor 152, the first delivery sensor 195, the second delivery sensor 197, the manual-feeding sheet detection sensor 214, and the media sensor 280. Some other examples of the various sensors connected to the I/O 307 include a fixing motor stable rotation detection sensor 174, a first sheet length detection sensor 218, a second sheet length detection sensor 219, and a manual-feeding sheet width volume sensor 217.

The CPU 301 controls the operation of the image forming apparatus 100 by executing computer programs stored in the ROM 302. The RAM 303 provides a work area for the CPU 301 during the execution of processing. The CPU 301 acquires detection results from the various sensors via the I/O 307 and controls the operation of the various motors via the I/O 307 based on the detection results concerned. In this way, the CPU 301 performs sheet feeding control and controls the fixing portion 170.

The CPU 301 of the control unit 300 starts printing operation when, for example, a printing operation start command (hereinafter referred to as “job”) is received from the UI 330. The CPU 301 can receive a job from the network I/F 314 or the fax I/F 315. The network I/F 314 receives a job from an external device, such as a personal computer, through a network, for example. The fax I/F 315 receives a job by facsimile communication.

In response to reception of a job, the CPU 301 causes the image processing unit 316 to perform image processing on an image to be printed. Examples of the image processing performed by the image processing unit 316 include image expansion and image rotation. The CPU 301 causes the image forming portion 320 to control the operation of each of the constituent components arranged in the image forming apparatus 100 so that the processing for printing an image on a sheet of paper is performed. The image forming portion 320 is capable of performing high-voltage application control and drive control for, for example, the process unit 120, the transfer belt 130, and the secondary transfer portion 140 illustrated in FIG. 1 and is capable of controlling the laser scanner unit 110 illustrated in FIG. 1. The image forming portion 320 is also capable of performing heater control for the fixing portion 170 illustrated in FIG. 1.

The CPU 301 which has acquired a job interprets the job and starts printing operation. The CPU 301 which has started the printing operation performs sheet feeding operation.

The procedure for feeding sheets of paper from the sheet feeding cassette 150 is as follows. The CPU 301 drives the pre-fixing conveyance motor 145 via the I/O 307 such that the pickup roller 151 is rotationally driven. As the pickup roller 151 rotates, one sheet of paper is fed at a time from the sheet feeding cassette 150. In this case, the CPU 301 determines, based on detection results obtained from the pickup sensor 152, whether the sheet feeding operation has been performed properly.

The procedure for feeding sheets of paper from the manual feeding tray 210 is as follows. With sheets of paper being placed on the manual feeding tray 210, a command for conveying the sheets of paper on the manual feeding tray 210 is input through the UI 330. The CPU 301 determines, based on detection results obtained from the manual-feeding sheet detection sensor 214, the presence or absence of sheets of paper on the manual feeding tray 210. The CPU 301 drives the manual feeding conveyance motor 147 via the I/O 307 such that the pickup rollers 211 are rotationally driven. As the pickup rollers 211 rotate, one sheet of paper is fed at a time from the manual feeding tray 210.

In a case where a sheet of paper is fed, the media sensor 280 determines the sheet property, such as the surface property and thickness, of the fed sheet of paper. The CPU 301 detects the sheet property based on detection results obtained from the media sensor 280. The CPU 301 sets the operating conditions, such as the fixing temperature, the transfer bias voltage, and the sheet conveyance speed, for image forming control based on the detected sheet property to perform image formation.

While performing the sheet feeding operation, the CPU 301 causes the process unit 120 to start performing image forming operation so as to be in time for the arrival of the sheet of paper at the secondary transfer portion 140. The process unit 120 performs the image forming operation in the manner as described above.

The CPU 301 determines, based on detection results obtained from the first conveyance sensor 160, the position of the sheet of paper conveyed by the conveyance rollers A 153, the conveyance rollers B 154, and the conveyance rollers C 155. The CPU 301 controls the transfer of the sheet of paper based on the time of detection of the leading edge of the sheet of paper by the first conveyance sensor 160 so that the leading edge of the sheet of paper and the leading edge of the toner image on the transfer belt 130 are brought into alignment with each other at the secondary transfer portion 140. For example, in a case where the sheet of paper is detected by the first conveyance sensor 160 ahead of the expected timing based on the relative position of the toner image, the CPU 301 brings the sheet of paper to a standstill at the pre-registration conveyance rollers 161 and resumes the conveyance after the lapse of a predetermined amount of time.

The CPU 301 transfers the toner image onto the sheet of paper by the application of the secondary transfer bias voltage to the sheet of paper and the toner image which have arrived at the secondary transfer portion 140. The sheet of paper on which the toner image has been transferred is conveyed to the fixing portion 170 by way of the conveyance belt 190. The CPU 301 causes the fixing motor 173 to drive a fixing roller included in the fixing portion 170 such that the toner image is thermally fixed to the sheet of paper. The sheet of paper with the image fixed thereto is then conveyed further downstream in the conveyance direction of the sheet of paper.

In a case where the leading edge of the sheet of paper with the image fixed thereto is detected by the second conveyance sensor 171, the CPU 301 makes a determination as to which one of the conveyance path A 230, the conveyance path B 231, and the conveyance path C 234 is to be used for conveyance of the sheet of paper, in accordance with the content of the job specified in advance through the UI 330. The CPU 301 controls the flapper A 172 and the flapper B 182 in accordance with the determination result, to thereby switch among the sheet guideways. Specifically, in a case where a sheet of paper undergoes double-sided printing or is to be delivered to the delivery port A 200 with the print side facing down, the CPU 301 shifts the flapper A 172 to guide the sheet of paper into the conveyance path A 230. In a case where printing on one side of a sheet of paper for single-sided printing or printing on both sides of a sheet of paper for double-sided printing is completed, the CPU 301 guides the sheet of paper into one of the conveyance path B 231 and the conveyance path C 234. In a case where a sheet of paper is to be delivered to the delivery port B 196 or the delivery port C 199, the CPU 301 shifts the flapper B 182 to guide the sheet of paper into the conveyance path B 231. In a case where a sheet of paper is to be delivered to the delivery port A 200, the CPU 301 shifts the flapper A 172 and the flapper B 182 to guide the sheet of paper into the conveyance path C 234.

In a case where a sheet of paper is conveyed to the conveyance path B 231, the CPU 301 causes the post-fixing conveyance motor 146 to drive the conveyance rollers D 162 and the conveyance rollers E 232 to convey the sheet of paper to the conveyance path D 181. The CPU 301 then causes the first delivery conveyance motor 148 to drive the delivery rollers A 241 and the delivery rollers B 242 such that the sheet of paper is conveyed toward the delivery port B 196 and the delivery port C 199.

In a case where the sheet of paper is to be delivered to the delivery port B 196, the CPU 301 shifts the flapper 183 to guide the sheet of paper into the delivery path A 193. The CPU 301 then causes the first delivery conveyance motor 148 to drive the delivery rollers C 243 such that the sheet of paper is delivered to the delivery port B 196. In a case where the sheet of paper is to be delivered to the delivery port C 199, the CPU 301 shifts the flapper 183 to guide the sheet of paper into the delivery path B 184. The CPU 301 then causes the second delivery conveyance motor 149 to drive the delivery rollers D 244, the delivery rollers E 245, and the delivery rollers F 246 such that the sheet of paper is delivered to the delivery port C 199.

In a case where a sheet of paper undergoing single-sided printing is to be delivered to the delivery port A 200 with the print side facing down, the CPU 301 shifts the flapper A 172 and controls rotation of the reverse rollers 163 such that the sheet of paper is conveyed as described above. In a case where printing on the first side of a sheet of paper for double-sided printing is completed, the CPU 301 shifts the flapper A 172 to guide the sheet of paper into the duplex reverse conveyance path 233. The CPU 301 controls rotation of the reverse rollers 163, the duplex conveyance rollers A 164, the duplex conveyance rollers B 165, the duplex conveyance rollers C 166, the duplex conveyance rollers D 179, and the duplex conveyance rollers E 168 to convey the sheet of paper to the duplex reverse conveyance path 233. The CPU 301 then reverses the direction of rotation of the duplex conveyance rollers E 168 and controls rotation of the duplex conveyance rollers G 175, the duplex conveyance rollers H 176, and the duplex conveyance rollers I 177 such that the sheet of paper is conveyed to the conveyance path 41 as described above.

An image specified by the job is printed on a specified number of sheets of paper. The printing operation pertaining to the job comes to an end in a case where the sheets of paper with the specified image printed thereon are all delivered. In a case where the entire job is completed, the CPU 301 causes the UI 330 to display an indication of the completion of the job.

### <Media Sensor>

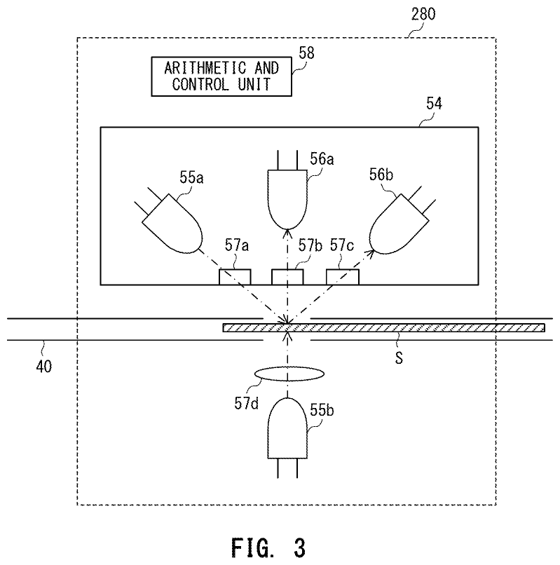

FIG. 3 is a configuration diagram of the media sensor 280. The media sensor 280 in the at least one embodiment is used to detect the sheet property or, more specifically, the surface property and thickness of sheets of paper. The media sensor 280 includes a media sensor unit 54, an external light emitting diode (LED) 55b, a light collection guide 57d, and an arithmetic and control unit 58. The LED 55b is an external light source. The media sensor unit 54 includes an LED 55a and phototransistors 56a and 56b and has slits 57a, 57b, and 57c. The LED 55a is a built-in light source, and the phototransistors 56a and 56b are built-in photoreceivers. The arithmetic and control unit 58 controls the operation of the media sensor 280 and performs arithmetic operations in accordance with output values obtained from the phototransistors 56a and 56b.

In a case where the media sensor 280 detects the surface property of sheets of paper, each of which is hereinafter referred to as “sheet of paper S”, the media sensor 280 operates as described below. Light emitted from the LED 55a passes through the slit 57a and strikes the surface of the sheet of paper S conveyed along the conveyance path 40. The phototransistor 56a receives light that is reflected off the surface of the sheet of paper S and collected through the slit 57b. The phototransistor 56b receives light that is reflected off the surface of the sheet of paper S and collected through the slit 57c.

The procedure for determining the surface property of the sheet of paper S is as follows.

The phototransistor 56a receives light that is emitted from the LED 55a as a light source and diffusedly reflected by the sheet of paper S. The phototransistor 56a then outputs a diffuse reflection output value derived from the amount of diffusedly reflected light received by the phototransistor 56a. The phototransistor 56b receives light that is emitted from the LED 55a as a light source and specularly reflected by the sheet of paper S. The phototransistor 56b then outputs a specular reflection output value derived from the amount of specularly reflected light received by the phototransistor 56b. The surface property “x” of the sheet of paper S, which is derived from the values output by the phototransistors 56a and 56b, is given by the following expression.

Surface Property x=(Specular Reflection Output Value)/(Diffuse Reflection Output Value) Expression 1

Expression 1 is a function which uses a characteristic that when the surface property of the sheet of paper S is “smoother” and “finer”, a greater amount of light is specularly reflected. The arithmetic and control unit 58 performs arithmetic operations by using Expression 1 to quantify the surface property of the sheet of paper S and then transmits the calculated value (surface property “x”) to the CPU 301. The CPU 301 determines the surface property of the sheet of paper S by using the acquired surface property “x” and a threshold value for determining the surface property. When the surface property “x” is greater than the threshold value, it is determined that the surface is “smooth” and “fine”. When the surface property “x” is smaller than the threshold value, it is determined that the surface is “rough” and “coarse”. Although the CPU 301 in the at least one embodiment determines the surface property by using one threshold value, the CPU 301 may determine the surface property by using a plurality of threshold values for more minute classification of the surface property.

The procedure for determining the thickness of the sheet of paper S is as follows. The conveyance path 40 has an opening through which the external LED 55b irradiates the sheet of paper S with light.

Light emitted from the external LED 55b as a light source passes through the light collection guide 57d and strikes the back side of the sheet of paper S. At least part of the light is transmitted through the sheet of paper S. The light transmitted through the sheet of paper S passes through the slit 57b and is then received by the phototransistor 56a. The phototransistor 56a outputs a specular transmission output value derived from the amount of transmitted light received by the phototransistor 56a. The arithmetic and control unit 58 detects the transmittance of the sheet of paper S from the specular transmission output value. The arithmetic and control unit 58 then transmits the detected transmittance to the CPU 301. In a case where the sheet of paper S becomes thicker, the transmittance of the sheet of paper S becomes lower. Conversely, in a case where the sheet of paper S becomes thinner, the transmittance of the sheet of paper S becomes higher. The thickness-dependent nature of transmittance serves as the basis for determining the thickness of the sheet of paper S.

The CPU 301 determines the thickness of the sheet of paper S based on the acquired transmittance and a threshold value for determining the thickness. In the at least one embodiment, the sheets S classified by thickness fall into three categories: “thick”, “medium”, and “thin”. The CPU 301 uses a thick-thin identification threshold value A and a thick-thin identification threshold value B as threshold values for determining the thickness. The thick-thin identification threshold value A is greater than the thick-thin identification threshold value B.

In a case where the transmittance of the sheet of paper S is higher than the thick-thin identification threshold value A, the CPU 301 determines that the sheet of paper S is “thin”. In a case where the transmittance of the sheet of paper S is lower than the thick-thin identification threshold value B, the CPU 301 determines that the sheet of paper S is “thick”. In a case where the transmittance of the sheet of paper S is lower than the thick-thin identification threshold value A and higher than the thick-thin identification threshold value B, the CPU 301 determines that the sheet of paper S is a sheet of “medium thickness”. Although the CPU 301 in the at least one embodiment uses two thick-thin identification threshold values, the CPU 301 may determine the thickness of the sheet of paper S by using one thick-thin identification threshold value or by using three or more thick-thin identification threshold values for more minute classification.

Although the media sensor 280 in the at least one embodiment is, for example, an optical sensor as described above, the media sensor 280 may be any other sensor capable of determining the sheet property, such as the surface property and thickness, of the sheet of paper S. For example, the media sensor 280 may be a sensor of any other kind, such as an ultrasonic sensor that uses reflection or transmittance of ultrasound. The settings pertaining to the surface property and thickness of the sheet of paper S may be made manually by the user through the UI 330, without the use of the media sensor 280. The sheet property to be detected by the media sensor 280 may be at least one of the surface property and the thickness, or may be properties other than the surface property and the thickness.

### <Identification Results Obtained by Media Sensor>

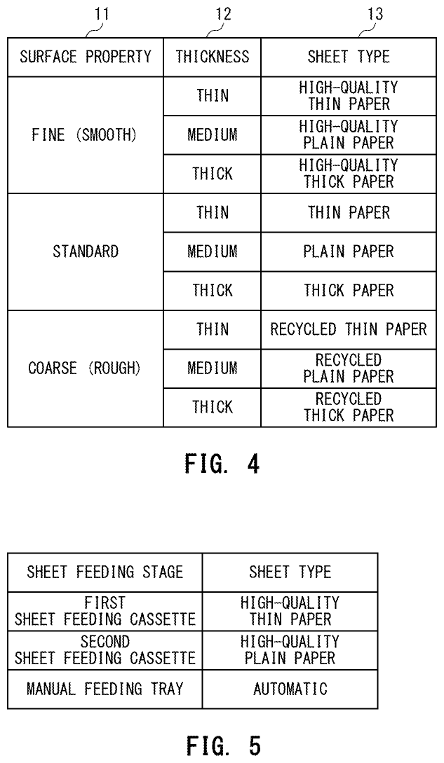

FIG. 4 is an explanatory table of sheet identification results obtained by the media sensor 280. In the at least one embodiment, three different surface properties 11 (“fine (smooth)”, “standard”, and “coarse (rough)”) and three different thicknesses 12 (“thin”, “medium”, and “thick”) are defined as detection patterns. As to a sheet type 13, it is automatically identified from 9 types. The nine categories included in the sheet type 13 in the at least one embodiment are “high-quality thin paper”, “high-quality plain paper”, “high-quality thick paper”, “thin paper”, “plain paper”, “thick paper”, “recycled thin paper”, “recycled plain paper”, and “recycled thick paper”. The CPU 301 detects the sheet property based on detection results (the surface property “x” and the transmittance) obtained from the media sensor 280 and then identifies the sheet type based on the detected sheet property.

FIG. 5 is an explanatory table of sheet feeding stage information indicating the types of sheets placed on sheet feeding stages of the sheet feeder. The sheet feeding stages in the at least one embodiment are the sheet feeding cassettes 150 and 220 and the manual feeding tray 210. In this case, the sheet feeding cassette 150 and the sheet feeding cassette 220 correspond to a first sheet feeding cassette and a second sheet feeding cassette, respectively. The sheet feeding stage information concerning the type of sheet on each of the sheet feeding stages is stored in the RAM 303. In FIG. 5, the type of sheet loaded in the first sheet feeding cassette is “high-quality thin paper”, and the type of sheet loaded in the second sheet feeding cassette is “high-quality plain paper”. No sheet type settings are made for the manual feeding tray 210, in which case the type of sheet on the manual feeding tray 210 is automatically identified through use of the media sensor 280 (“automatic”).

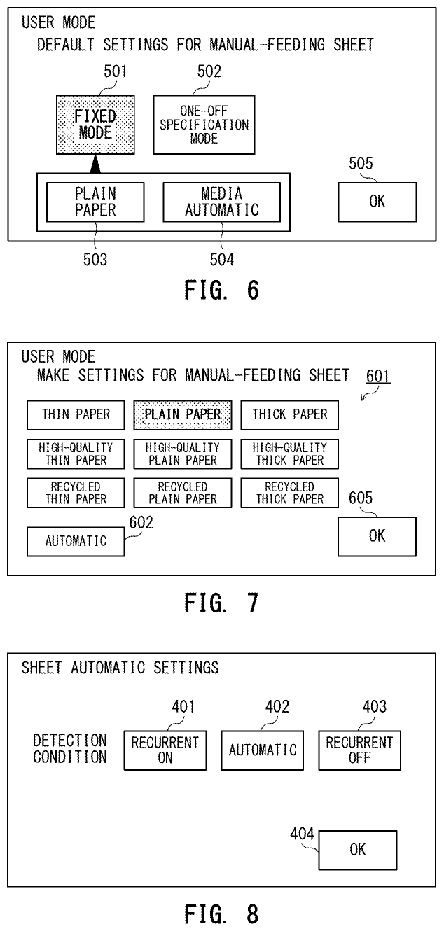

The following describes the procedure for making sheet type settings for the manual feeding tray 210. When placing sheets of paper on the manual feeding tray 210, the user can make sheet type settings for the manual feeding tray 210 in the following manner. The user first operates the UI 330 to display a sheet type setting screen for the manual feeding tray 210 on the display 334. FIG. 6 is an exemplary view of the setting screen.

A fixed mode selection button 501, a one-off specification mode selection button 502, and an OK button 505 are displayed on the setting screen. The fixed mode selection button 501 is a button for use in fixing the settings selected for the type of sheet on the manual feeding tray 210. The one-off specification mode selection button 502 is a button for use in making a setting about the sheet type every time the user places sheets of paper on the manual feeding tray 210. In an example illustrated in FIG. 6, the fixed mode selection button 501 is selected, in which case selection between a sheet type selection button 503 and a media automatic selection button 504 is allowed. The sheet type selection button 503 enables the user to select the sheet type for the fixed sheet type settings. The media automatic selection button 504 enables the user to select “automatic” for automatic selection of the sheet type. In a case where the sheet type selection button 503 is selected through use of UI 330, a sheet type selection screen is displayed on the display 334. FIG. 7 is an exemplary view of the selection screen.

A sheet type selection button group 601, an automatic setting button 602, and an OK button 605 are displayed on the selection screen. The user selects a sheet type by using the UI 330, specifically, the user makes a selection from among the sheet types included in the sheet type selection button group 601 or selects the automatic setting button 602 and then depresses the OK button 605. In a case where a selection is made from among the sheet types included in the sheet type selection button group 601, the sheet type settings for the manual feeding tray 210 are set to the selected sheet type. In a case where the automatic setting button 602 is selected, the sheet type settings for the manual feeding tray 210 are adjusted to “automatic”. Once the sheet type settings are set to “automatic”, the type of sheet on the manual feeding tray 210 is automatically identified through use of the media sensor 280.

Depressing the OK button 605 in the selection screen of FIG. 7 restores the display 334 to the setting screen of FIG. 6. The item displayed as the sheet type selection button 503 is the sheet type selected on the selection screen of FIG. 7. Given that “plain paper” is selected on the selection screen, “plain paper” is displayed as the sheet type selection button 503. A transition to the selection screen of FIG. 7 does not occur in a case where the media automatic selection button 504 is selected on the setting screen illustrated in FIG. 6, in which case the sheet type settings for the manual feeding tray 210 is set to “automatic”.

In a case where the media automatic selection button 504 is selected on the setting screen of FIG. 6, an automatic setting screen illustrated in FIG. 8 is displayed on the display 334. The automatic setting screen allows the user to set a sheet detection condition for the media sensor 280. A “recurrent ON” button 401, an “automatic” button 402, a “recurrent OFF” button 403, and an OK button 404 are displayed on the automatic setting screen. The user can set a sheet detection condition by using the UI 330, specifically, the user makes a selection from among the “recurrent ON” button 401, the “automatic” button 402, and the “recurrent OFF” button 403 and then depresses the OK button 404.

The “recurrent ON” button 401 is a button for use in turning on the setting in which the media sensor 280 routinely detects the first sheet of paper at the start of a job and at the time of the resumption of the job after suspension. Once the “recurrent ON” button 401 is selected, the sheet type is automatically identified every time a job is started and every time the job is resumed after suspension. The “automatic” button 402 is a button for use in turning on the setting in which whether the media sensor 280 detects the first sheet of paper is determined at the time of the resumption of a job after suspension. Once the “automatic” button 402 is selected to set the sheet detection condition to “automatic”, whether the media sensor 280 detects the first sheet of paper at the time of the resumption of a job after suspension is automatically determined based on a factor responsible for the suspension of the job. The “recurrent OFF” button 403 is a button for use in turning on the setting at which the media sensor 280 does not detect the first sheet of paper at the start of a job and at the time of the resumption of the job after suspension.

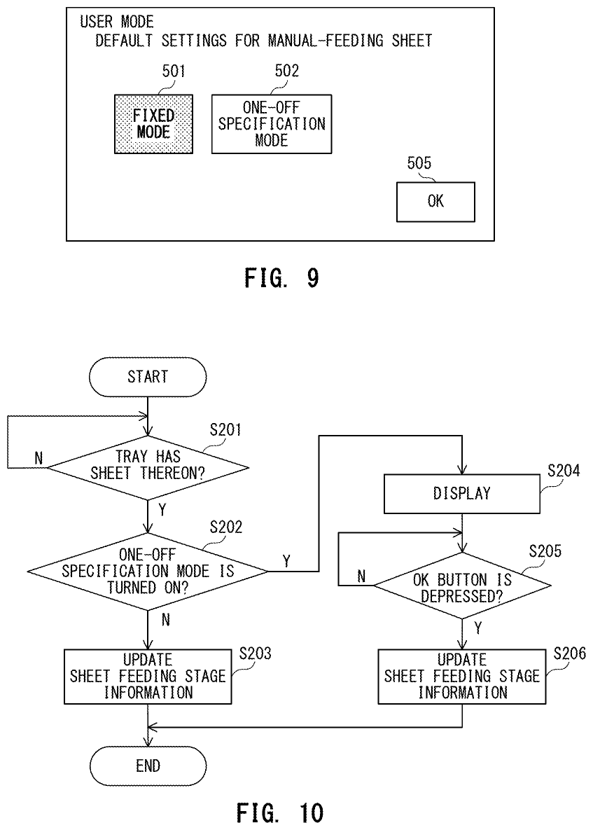

FIG. 9 is an exemplary view of a setting screen on which the one-off specification mode selection button 502 of FIG. 6 is selected. In a case where sheets of paper are placed on the manual feeding tray 210 under a state in which the one-off specification mode selection button 502 is selected, the selection screen of FIG. 7 is displayed on the display 334. The user is prompted to make a selection from among the sheet types displayed on the selection screen every time the user places sheets of paper on the manual feeding tray 210. Information about the settings made on the screens of FIG. 6 to FIG. 9 is stored in the RAM 303.

FIG. 10 is a flowchart for illustrating processing for making settings concerning the sheet feeding stage information of FIG. 5. The flowchart is an illustration of the flow of the procedure to be followed from time when sheets of paper are placed on the manual feeding tray 210 to when the sheet feeding stage information is stored in the RAM 303.

The CPU 301 is kept on standby until sheets of paper are placed on the manual feeding tray 210 (Step S201: N). The CPU 301 can determine whether sheets of paper are placed on the manual feeding tray 210, based on the detection results obtained from the manual-feeding sheet detection sensor 214. In a case where sheets of paper are placed on the manual feeding tray 210 (Step S201: Y), the CPU 301 searches through the RAM 303 to determine whether a one-off specification mode is turned on (Step S202).

In a case where the one-off specification mode is not turned on (Step S202: N), the CPU 301 updates the sheet type settings for the manual feeding tray 210 in the sheet feeding stage information based on the settings made on the setting screen of FIG. 6 (Step S203). In a case where the sheet type settings are set to “automatic”, the sheet feeding stage information is updated based on results obtained by media automatic identification processing, which is described later.

In a case where the one-off specification mode is turned on (Step S202: Y), the CPU 301 displays the selection screen of FIG. 7 on the display 334 (Step S204). The CPU 301 is kept on standby until the OK button 605 is depressed after a selection is made from among the sheet types displayed on the selection screen (S205: N). In a case where the OK button 605 is depressed (Step S205: Y), the CPU 301 updates the sheet type settings for the manual feeding tray 210 in the sheet feeding stage information based on the sheet type selected on the selection screen (Step S206). Then, the processing for making settings concerning the sheet feeding stage information ends.

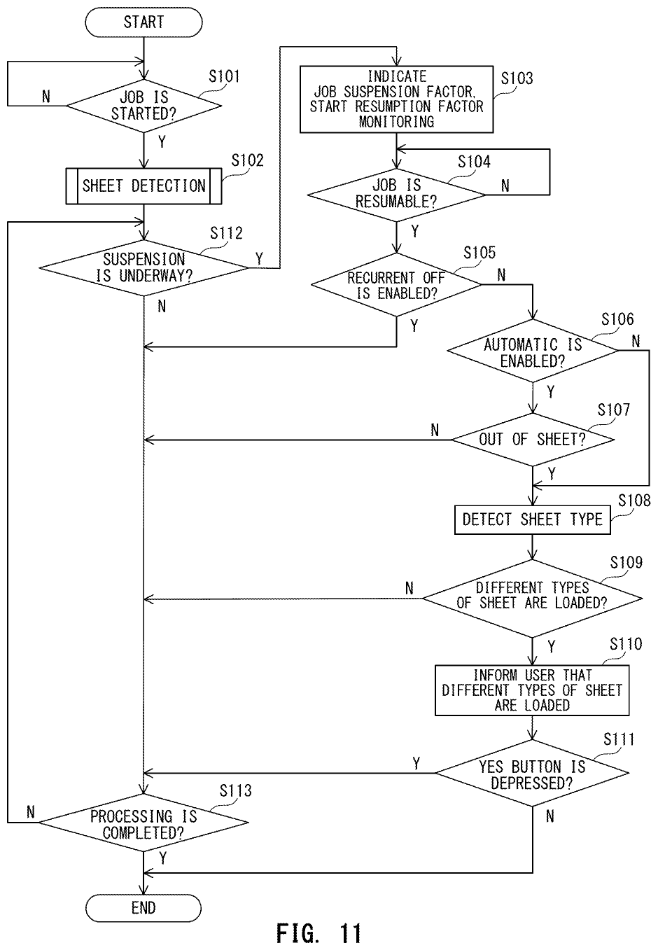

FIG. 11 is a flowchart for illustrating the media automatic identification processing executed in the state in which the sheet type settings are set to “automatic”. With the sheet type settings being set to “automatic”, the media sensor 280 detects a sheet of paper conveyed upon start of a job, and the sheet type settings are made accordingly.

The CPU 301 is kept on standby until a job is started (Step S101: N). In a case where a job is started (Step S101: Y), the CPU 301 performs job-start-time sheet detection processing (Step S102). The job-start-time sheet detection processing is described in detail later. The CPU 301 identifies the sheet property and the sheet type based on sheet detection results and then determines operating conditions for image forming control based on the identified sheet property.

Once the sheet detection processing is completed, printing processing is executed, and in the meantime, the CPU 301 determines whether an incident considered as a job suspension factor has occurred before the completion of the job (Step S112). The printing processing is executed based on the operating conditions for image forming control that are set based on the sheet property. Various incidents such as “out of sheet”, “sheet jam”, “out of toner”, and “delivery portion full” can each be a factor responsible for the suspension of a job. In a case where such an incident makes it difficult to proceed with a job, the CPU 301 determines that an incident considered as a job suspension factor has occurred. The CPU 301 can detect those factors by using the various sensors arranged in the image forming apparatus 100. In a case where such an incident that can be a factor responsible for suspension of a job before completion of the job has not occurred (Step S112: N), the CPU 301 determines whether the printing processing for the job is completed (Step S113). In a case where the printing processing has not been completed yet (Step S113: N), the process returns to Step S112, and the CPU 301 continuously determines whether an incident considered as a job suspension factor has occurred while the printing processing is underway. In a case where the printing processing is completed (Step S113: Y), the CPU 301 ends the identification processing.

In a case where an incident considered as a job suspension factor occurs before completion of the job (Step S112: Y), the CPU 301 causes the display 334 to display a job suspension factor and causes the resumption factor monitoring unit 305 to start resumption factor monitoring to monitor whether the job suspension factor is eliminated (Step S103). FIG. 12 is an exemplary view of a display screen on which a suspension factor is indicated. The display screen of FIG. 12 is displayed in a case where the suspension factor is “out of sheet”, that is, there is no sheet placed on the manual feeding tray 210.

The CPU 301 is kept on standby until the suspension factor is eliminated to make the job resumable (Step S104: N). In the example illustrated in FIG. 12, placing sheets of paper on the manual feeding tray 210 eliminates the suspension factor. In this case, as a resumption factor (a factor in resumption of the suspended job), the CPU 301 can detect whether sheets of paper are placed on the manual feeding tray 210 based on detection results obtained from the manual-feeding sheet detection sensor 214.

In a case where the job is resumable (Step S104: Y), the CPU 301 determines whether “recurrent OFF” on the automatic setting screen of FIG. 8 is enabled as the sheet detection condition (Step S105). In a case where “recurrent OFF” is enabled (Step S105: Y), the sheet type is not identified. In this case, the CPU 301 resumes the job under the operating conditions determined in the processing step of Step S102 and then determines whether the printing processing for the job is completed (Step S113). In a case where the printing processing has not been completed yet (Step S113: N), the process returns to Step S112, in which case the CPU 301 continuously determines whether an incident considered as a job suspension factor has occurred while the printing processing is underway. In a case where the printing processing is completed (Step S113: Y), the CPU 301 ends the identification processing.

In a case where “recurrent OFF” is not enabled (Step S105: N), the CPU 301 determines whether “automatic” is enabled as the sheet detection condition (Step S106). In a case where “automatic” is enabled (Step S106: Y), the CPU 301 determines whether the job suspension factor is “out of sheet” (Step S107). In a case where the suspension factor is not “out of sheet” (Step S107: N), there is a low possibility that sheets of paper are added to the manual feeding tray 210, and hence there is a low possibility that a different type of sheet is mistakenly placed on the manual feeding tray 210. The CPU 301 can thus determine that there is no need to reidentify the sheet type. In this case, the CPU 301 resumes the job under the operating conditions determined in the processing step of Step S102 and then determines whether the printing processing for the job is completed (Step S113). In a case where the printing processing has not been completed yet (Step S113: N), the process returns to Step S112, in which case the CPU 301 continuously determines whether an incident considered as a job suspension factor has occurred while the printing processing is underway. In a case where the printing processing is completed (Step S113: Y), the CPU 301 ends the identification processing.

When “automatic” is not enabled as the sheet detection condition (Step S106: N) and when the job suspension factor is “out of sheet” (Step S107: Y), there is a need to identify the sheet type of the first sheet of paper fed at the time when the suspended job is resumed. Thus, the CPU 301 performs sheet feeding operation and acquires detection results from the media sensor 280 in this case to reidentify the sheet type (Step S108). After detecting the sheet property based on the acquired detection results, the CPU 301 redetermines the operating conditions for image forming control based on the detected sheet property.

The CPU 301 compares the sheet type detected in the processing step of Step S102 to the sheet type detected in the processing step of Step S108 to determine whether different types of sheets are loaded for use in the same job (Step S109). In a case where the sheet type detected in the processing step of Step S102 is the same as the sheet type detected in the processing in Step S108, it is determined that only one type of sheet is loaded. In a case where the sheet type detected in the processing step of Step S102 differs from the sheet type detected in the processing step of Step S108, it is determined that different types of sheets are loaded.

In a case where different types of sheets are not loaded (Step $109: N), the CPU 301 resumes the job under the operating conditions determined in the processing step of Step S102 and then determines whether the printing processing for the job is completed (Step S113). In a case where the printing processing has not been completed yet (Step S113: N), the process returns Step S112, in which case the CPU 301 continuously determines whether an incident considered as a job suspension factor has occurred while the printing processing is underway. In a case where the printing processing is completed (Step S113: Y), the CPU 301 ends the identification processing.

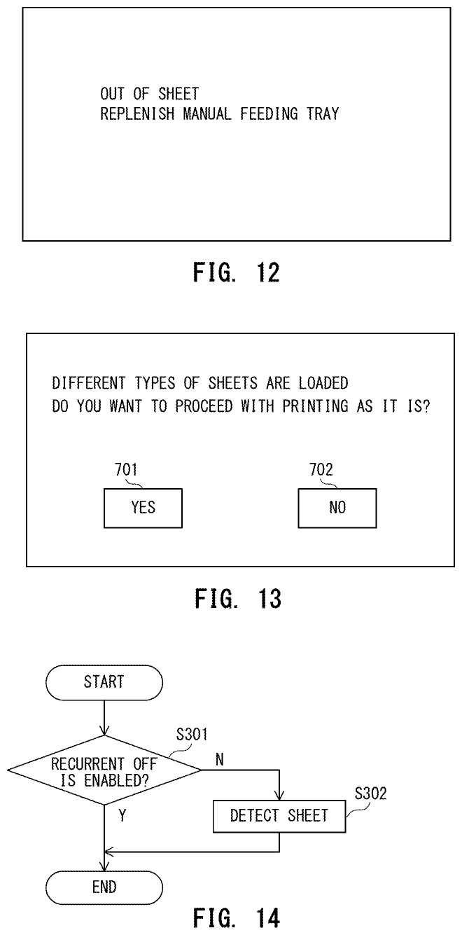

In a case where different types of sheets are loaded (Step S109: Y), the CPU 301 informs the user that different types of sheets are loaded (Step S110). FIG. 13 is an exemplary view of a notification screen for informing the user that different types of sheets are loaded. The CPU 301 displays the notification screen on the display 334 to inform the user that different types of sheets are loaded. The notification screen cautions the user that the tray in a sheet-out condition is mistakenly replenished with a different type of sheet. The user can proceed with the job as it is by depressing a “YES” button 701 on the notification screen or can suspend the job by depressing a “NO” button 702 on the notification screen.

In a case where the “YES” button 701 is depressed (Step S111: Y), the CPU 301 resumes the job under the operating conditions newly determined in the processing step of Step S108 and then determines whether the printing processing for the job is completed (Step S113). In a case where the printing processing has not been completed yet (Step S113: N), the process returns to Step S112, in which case the CPU 301 continuously determines whether an incident considered as a job suspension factor has occurred while the printing processing is underway. In a case where the printing processing is completed (Step S113: Y), the CPU 301 ends the identification processing. In a case where the “NO” button 702 is depressed (Step S111: N), the CPU 301 ends the job and then ends the identification processing.

The following describes the job-start-time sheet detection processing in Step S102 of FIG. 11. FIG. 14 is a flowchart for illustrating the job-start-time sheet detection processing.

The CPU 301 determines whether “recurrent OFF” is enabled as the sheet detection condition (Step S301). In a case where “recurrent OFF” is enabled as the detection condition (Step S301: Y), the CPU 301 does not detect sheet and ends the sheet detection processing. In a case where “recurrent OFF” is not enabled as the detection condition (Step S301: N), the CPU 301 performs sheet feeding operation to feed a sheet of paper and detects the sheet of paper by using the media sensor 280 (Step S302). The CPU 301 obtains sheet detection results from the media sensor 280 and then determines the sheet property and the sheet type based on the detection results. Then, the sheet detection processing ends.

As described above, the image forming apparatus 100 according to the at least one embodiment determines whether to reidentify the sheet type at the time of resumption of a suspended job in a manner that depends on the suspension factor. For example, the need for loading extra sheets of paper arises in a case where a job is suspended due to a sheet-out condition. In such a case, a different type of sheet can be mistakenly loaded. For this reason, the sheet type is reidentified in a case where the suspension factor is “out of sheet”. As a result of the reidentification of the sheet type, the operating conditions for image forming control are redetermined.

Comparing the sheet type identified at the start of a job to the sheet type identified at the time of the resumption of the suspended job enables a determination as to whether a different type of sheet is mistakenly loaded. In a case where a different type of sheet is loaded, notification is provided to the user by way of caution. This eliminates or reduces the possibility that different types of sheets are loaded for the same job.

In a case where the image forming apparatus 100 is configured as described above, the redetermination of the sheet property and reidentification of the sheet type become less frequent. This leads to a reduction in the standby time during which the operating conditions are redetermined following the redetermination of the sheet property. This suppresses the reduction in printing productivity.

### Another Example of Media Sensor

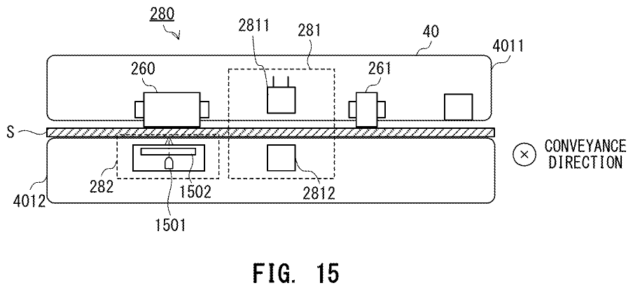

FIG. 15 is a configuration diagram of another example of the media sensor 280. The control unit 300 can detect the sheet property by using this media sensor 280. FIG. 15 is a diagram for illustrating the media sensor 280 as viewed in the direction of conveyance of the sheet of paper S (from the side on which the conveyance rollers C 155 are located). The media sensor 280 includes an ultrasonic sensor 281 and an optical sensor 282 to detect the sheet property, such as the surface property and basis weight, of the sheet of paper S. The ultrasonic sensor 281 is configured from an ultrasonic transmitter 2811 and an ultrasonic receiver 2812. The optical sensor 282 is configured as, for example, a contact image sensor (CIS) including a light source 1501 and a line sensor 1502. The light source 1501 may, for example, be an LED.

It is required that a sheet of paper be held at an optical focal point in a case where the optical sensor 282 detects a luminance value. It is also required that the interference from the sheet of paper S fluttering during conveyance be reduced in a case where ultrasound is used to detect the sheet of paper S. Those requirements are addressed by a media sensor counter roller 260 and a sheet pressing roller 261, which are arranged between the conveyance rollers C 155 and the pre-registration conveyance rollers 161 to steady the orientation of the sheet of paper S. The media sensor counter roller 260 is arranged opposite to the optical sensor 282 to press the sheet of paper S against the optical sensor 282. This reduces fluctuations in the position and orientation of the sheet of paper S while the media sensor 280 is making measurements on the surface of the sheet of paper S. The media sensor 280 can therefore measure the surface property and basis weight of the sheet of paper S with stability.

As illustrated in FIG. 15, the ultrasonic transmitter 2811 and the ultrasonic receiver 2812 are arranged in an upper block 4011 and a lower block 4012, respectively, with the conveyance path 40 for the sheet of paper S being sandwiched therebetween. The ultrasonic sensor 281 is configured to transmit and receive ultrasound through the sheet of paper S to output information (output voltage) for determining the basis weight of the sheet of paper S. Herein, the basis weight is the mass per unit area of the sheet of paper S and is measured in units of gsm.

The ultrasonic transmitter 2811 and the ultrasonic receiver 2812 each include a piezoelectric element (also referred to as “piezo element”) and an electrode terminal. The piezoelectric element converts mechanical displacement into electrical signals, and vice versa. In a case where the pulse voltage with a predetermined frequency is applied to the electrode terminal of the ultrasonic transmitter 2811, the piezoelectric element of the ultrasonic transmitter 2811 oscillates such that ultrasound is generated. The generated ultrasound propagates through the air. The ultrasound then reaches the sheet of paper S and causes the sheet of paper S to vibrate. That is, ultrasound generated by the ultrasonic transmitter 2811 is transmitted to the ultrasonic receiver 2812 through the sheet of paper S. The piezoelectric element of the ultrasonic receiver 2812 receives the ultrasound transmitted through the sheet of paper S and then generates an output voltage corresponding to the amplitude of the received ultrasound at the electrode terminal of the ultrasonic receiver 2812. Herein, the transmittance is the ratio of the output voltage in the presence of the sheet of paper S between the ultrasonic transmitter 2811 and the ultrasonic receiver 2812 to the output voltage in the absence of the sheet of paper S between the ultrasonic transmitter 2811 and the ultrasonic receiver 2812. Given that the transmittance of ultrasound varies depending on the basis weight (areal density) of the sheet of paper S, the basis weight of the sheet of paper S can be estimated with a conversion equation for converting the ultrasound transmission coefficient into the sheet basis weight.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-120844, filed Jul. 25, 2023, which is hereby incorporated by reference herein in its entirety.

What is claimed is:

1. An image forming apparatus comprising:
a sheet feeder in which sheets are to be loaded;
a conveyor configured to feed each of the sheets from the sheet feeder;
a sensor configured to detect a sheet property of the each of the sheets conveyed by the conveyor;
an image forming portion configured to form an image on the each of the sheets conveyed by the conveyor; and
a controller configured to control the image forming portion to form an image on each of a plurality of sheets in accordance with an operating condition based on the sheet property detected with the sensor in a case where a job for forming an image on the plurality of sheets is executed,
wherein, in a case where image formation is suspended before completion of the job, the controller is configured to control, depending on a factor responsible for the suspension of the image formation, whether to redetect a sheet property with the sensor upon resumption of the job is made.

2. The image forming apparatus according to claim 1, wherein the controller is configured to, in a case where the factor responsible for the suspension is a sheet-out condition in the sheet feeder, reidentify a sheet type based on the sheet property detected with the sensor.

3. The image forming apparatus according to claim 2, wherein the controller is configured to compare a sheet type identified at start of the job to a sheet type reidentified at a time of the resumption of the job to determine whether a different type of sheet is loaded in the sheet feeder.

4. The image forming apparatus according to claim 3, wherein, in a case where a different type of sheet is loaded in the sheet feeder, the controller is configured to inform a user that a different type of sheet is loaded.

5. The image forming apparatus according to claim 2, further comprising a sheet presence/absence sensor for detecting sheets loaded in the sheet feeder,
wherein the controller is configured to detect the factor responsible for the suspension based on a detection result obtained from the sheet presence/absence sensor.

6. The image forming apparatus according to claim 1, wherein the controller is configured to, upon reidentifying a sheet type based on the sheet property, newly determine an operating condition based on the sheet property detected with the sensor and reidentify the sheet type based on the newly determined operating condition.

7. The image forming apparatus according to claim 6, wherein the controller is configured to:
compare a sheet type identified at start of the job to a sheet type reidentified at a time of the resumption of the job; and
control, in a case where it is determined that the same type of sheet is loaded in the sheet feeder, the imaging forming portion to form an image in accordance with the operating condition determined at the start of the job.

8. The image forming apparatus according to claim 7, wherein the controller is configured to control, in a case where a different type of sheet is loaded in the sheet feeder, the image forming portion to form an image in accordance with the newly determined operating condition upon reception of notification given by a user to proceed with the job under a state in which the different type of sheet is loaded.
